(19) United States
(12) Patent Application Publication
(10) Pub. No.: US 2023/0015495 A1
(43) Pub. Date: Jan. 19, 2023

(54) Panel for Constructing a Floor or Wall Covering

(71) Applicant: LI&CO AG, Mustair (CH)

(72) Inventor: Edwin Lingg, Schluderns (IT)

(21) Appl. No.: 17/785,257

(22) PCT Filed: Dec. 18, 2020
(86) PCT No.: PCT/EP2020/087236

§ 371 Date: Jun. 14, 2022

(30) Foreign Application Priority Data
Dec. 18, 2019 (NL) 2024496
May 1, 2020 (NL) 2025476
Jul. 31, 2020 (NL) 2026186

(51) Int. Cl. E04F 15/08

(52) U.S. Cl. CPC E04F 15/085; E04F 2201/0153

(57) ABSTRACT

The invention relates to a panel for constructing a floor or wall covering and to a method for manufacturing such panel. The panel according to the present invention comprises at least one substantially flat support element comprising an upper surface, a lower surface, a first pair of opposed side edges and a second pair of opposed side edges, in combination with at least one decorative top layer which is affixed to the upper surface of the support element. The support element comprises wood fibers and at least one binder.

The invention relates to a panel for constructing a floor or wall covering. The invention also relates to a support element for use in such panel. The invention further relates to method of manufacturing a panel for constructing a floor or wall covering.

Ceramic tiles are widely used as a floor and wall covering in both residential and commercial applications. Ceramic tiles are available in a nearly unlimited color palette and may be installed in an equally unlimited number of designs. This tile is often a top choice for floor and wall coverings because of its waterproofness, great durability and aesthetic qualities. When tiles are installed, they are generally laid side by side on a surface such as a floor or wall. Typically, an adhesive compound is used as a base to attach the tiles to a supporting surface, after which grout is spread over and between the tiles to further bind the tiles to the supporting surface and to fill spaces between adjacent tiles. Due to the time and labor involved in tile installation, it is typically quite costly to have tile professionally installed. Accordingly, many homeowners desire to install tile in their own homes. Unfortunately, this is an extremely tedious process, and many homeowners do not wish to spend the time necessary for a satisfactory installation. In recent years, manufactures have attempted to produce do-it-yourself tile solutions that are easier to install. A difficulty, however, is that a click profiling section cannot be directly accomplished at the edges of the ceramic tiles, due to the hardness and brittleness of the material. In fact, the profiling processing cannot be performed directly on the ceramic since, during the profiling process, the milling cutters fail to affect and shape the profile to obtain the aforesaid connection system with the decimal tolerance required by the market of laminate flooring, LVT, or wooden parquet. In addition, the profiling can chip the ceramic material and give rise to breakages/abrasions/cracks or fissures so as to compromise the aesthetic appearance of the profiled element and the traction connection/sealing of the click joint.

There is demand for floor panels which are strong, resistant to impact, waterproof and stable under several conditions. There are types of laminate flooring which fulfills these requirements. An example is a laminate floor panel having a moisture resistant layer under a layer of high density fiberboard (HDF) or medium density fiberboard (MDF) in combination with a decorative top layer which is finished with an extremely hard, clear coating made from special resin-coated cellulose to protect it from wear and tear. The HDF and MDF which can be used as core material are types of so-called engineered wood. Wood-based floor panels are still rather popular over panels made from polymer materials due to their natural appearance. A drawback of engineered wood is that several subsequent production steps are required during production. A further drawback is that the known engineered woods are not waterproof, wherefore further protective material layers need to be applied in order to obtain a waterproof flooring panel. It can be understood that if such protective layer gets damaged, it might affect the entire panel.

It is a first goal of the present invention to provide a prefabricated waterproof panel or waterproof tile with a ceramic or equivalent top layer, and which can be installed in a relativity simple manner, preferably without using glue and/or grout.

It is a second goal of the present invention to provide a prefabricated multilayer waterproof panel or waterproof tile with a ceramic or equivalent top layer, which is dimensionally stable.

It is a third goal of the present invention to provide a prefabricated multilayer waterproof panel or waterproof tile with a ceramic or equivalent top layer, which is dimensionally stable in case of a change in moisture content and/or in case of a change in temperature.

It is a fourth goal of the present invention to provide a prefabricated multilayer waterproof panel or waterproof tile with a ceramic or equivalent top layer configured to be mechanically interconnected with other panels or tiles.

At least one of these goals can be achieved by providing a panel for constructing a floor or wall covering, comprising: at least one substantially flat support element comprising: an upper surface, a lower surface, a first pair of opposed side edges and a second pair of opposed side edges, wherein the support element is, preferably waterproof, and wherein the support element is at least partially made of at least one binder and, natural and/or synthetic particles, in particular fibers, and at least one decorative top layer which is affixed, either directly or indirectly, to the upper surface of the support element, wherein, preferably, the top layer is at least partially made of ceramic and/or stone, and/or any material chosen from the group consisting of: ceramic, stone, concrete, mineral porcelain, glass, quartz, soapstone, mosaic, granite, limestone and marble. Alternatively, a polymer top layer may be used. The application of the support element is advantageous to align, and preferably to interconnect, the panels during installation. As the support element is waterproof, the panels has as such is provided a waterproof character, which means that a change of moisture content in or on the panels does not affect the dimensions of the panels. Moreover, since the support element is at least partially wood-based, the support element is at least partially made of a natural material. Moreover, the wood content in the support element provides a desired thermal stability, and an improved stability with respect to for example PVC based materials. Furthermore, the waterproof, wood-based support element is ideally suitable to apply coupling profiles at one or more edges of the support element. This allows the possibility to realize a click interlocking ceramic (or stone of equivalent) floor obtained by connecting adjacent panels by means of a joint male/female connection, typically of a tongue-groove type or a click type, for example with known systems such as the vertical down-fold system, angle-angle system, or the like, preferably without using glue.

Pure wood, medium-density fiberboard (MDF), and high-density fiberboard (HDF) are not waterproof and therefore as such do not qualify as a suitable material to realize a waterproof support element. Hence, in order to realize a waterproof support element, the wood fibers present in the support element should be protected in an improved manner from external moisture, which can be realized in various manners, such as by having the wood fibers enclosed (enveloped) by a separate waterproof casing (waterproof envelope). However, this latter option is commonly laborious and costly and therefore less preferred than the more preferred options described below.

Preferably, the waterproof support element is at least partially made of a composite material, which composite material comprises: at least one binder selected from the group consisting of: a thermosetting (polymer) binder, and a mineral binder, in particular gypsum, mica, clay or cement; natural and/or synthetic particles, in particular natural and/or synthetic fibers, dispersed in said binder. Preferably, at least one type of natural particles is chosen from the group consisting of: plant particles and animal particles. Preferably, the composite material comprises less than 20% by weight of thermoplastic material, such as PVC. A lower amount of thermoplastic material will increase the temperature stability of the panel as such. Preferably, the composite material is free of thermoplastic material.

In a preferred embodiment, the binder is a thermosetting polymer binder chosen from the group consisting of: an epoxy resin, an acrylic resin, a polyurethane resin and a phenolic resin. Phenolic resins benefit of a high temperature stability, typically up to 300° to 350° C. Phenolic resins further benefit of a high water and chemical stability. These material characteristics make that a phenolic resin is suitable as binder for the purpose of the present invention. It is in particular preferred that the binder is or comprises a resol-type phenolic resin. Instead of a resol-type phenolic resin, it could also be referred to as phenolic resol, a resole type, a phenolic resole resin or combination thereof. A benefit of the resol-type phenolic resin is that this is a so-called one-step resin which can cure without using an additional cross linker. Curing of the resol-type phenolic resin can be initiated via heat, which is typically applied during production of the panel, as described in the corresponding method according to the present invention. The use of a resol-type of phenolic resin enables that a rather uncomplicated production process of the support element can be applied.

In a further preferred embodiment, the binder is a phenol-formaldehyde resin having a formaldehyde to phenol ratio which is at least 1. It is experimentally found that such resin can provide good bonding of the cellulose particles, such as plant fibers and wood fibers, which may contribute to obtaining the desired high density of the support element. Due to the adequate bonding between phenol-formaldehyde resin and plant and wood fibers, emission of volatile products, such as formaldehyde emission can be prevented. Typically, the ratio of formaldehyde to phenol is about 1.5. More preferably, the binder is a base-catalyzed phenol-formaldehyde. By using a base catalyst it can be achieved that a resol-type of phenol-formaldehyde resin is obtained. Typically, the binder used during manufacturing of the panel according to the present invention, which may be any of the abovementioned binders, has a solid content between 30 and 70%, preferably between 40 and 60%, more preferably between 45 and 55%. The presence of a solid content may increase the curing speed of the binder. It may further improve the final density and thus hardness of the support element and/or it may reduce the impact of emission of volatile compounds. Preferably, the binder has a viscosity between 10 and 100 m·Pas, in particular between 20 and 80 m·Pas, more in particular between 25 and 40 m·Pas at 25 degrees Celsius. A further non-limiting example of the viscosity of the binder to be used is 30 m·Pas. Cured phenolic resins are typically are approximately seven times less tougher than cured epoxy resins.

In a preferred embodiment, the composite material comprises a mineral binder comprising magnesium oxide, magnesium chloride and water. Here, the amount of magnesium oxide is preferably situated between 10% and 50%, more preferably between 25% and 35%, by weight of the composite material. The amount of magnesium chloride is preferably situated between 5% and 15%, more preferably between 5% and 10%, by weight of the composite material. The amount of water, which is typically present in bound (hydrated) form, is preferably situated between 10% and 30%, more preferably between 10% and 20%, by weight of the composite material.

In a preferred embodiment, the composite material comprises a mineral binder comprising calcium oxide, and less than 2%, preferably less than 0.9%, more preferably less than 0.6% by weight of sodium oxide (Na₂O). This composition is typically referred to as low-alkali cement. This cement has a relatively large resistance to allow a (alkali-silica) reaction between the alkaline constituent(s) of the cement and reactive amorphous silica (silicon dioxide) often present in the cement, which prevents cracking of the cement. Preferably, the composite material comprises sand, in particular quartz sand. The most common constituent of sand is silica. The addition of sand makes the cement more binding.

In another preferred embodiment, the composite material comprises a mineral binder comprising loam or clay, in particular terracotta. In addition to good sound insulation, loam and clay have the advantage that these materials are porous and allow large amounts of moisture to be absorbed. This keeps the humidity in a room relatively constant. In addition, clay is suitable for absorbing pollutants from the air. Clay also has great ecological advantages. It can be air dried, which does not cause any CO2 emissions. The special soundproofing effects of clay are achieved not only through its relatively high specific weight, but also through its soft, dampening structure, which reduces the vibrations of the wall.

It is also imaginable that the composite material comprises a mineral binder comprising mica. Mica is a phyllosilicate mineral, and may be used in ground form (powder). It is further imaginable that the composite material comprises a mineral binder comprising gypsum. Gypsum (calcium sulfate, CaSO₄.2H₂O) is a naturally occurring mineral. When heated above 120° C., a part of the chemically bound water is released and different mineral calcium sulfates like hemihydrate (CaSO₄0.5H₂O; formed at 130-160° C.) and anhydrite (CaSO₄; formed at 290-900° C.) are formed. Reaction of this partially or completely dehydrated gypsum with water leads to a setting and crystallization reaction which is the base of working as a mineral binder. Special hydrophobic polymers, such as polylactic acid, with additional hydrophobizing characteristics, or hydrophobizing additives, dramatically improve the water resistance of gypsum-/anhydrite-based mortars, so that they can be used even in humid environments. The gypsum based composite material may comprise starch. Starch may act as (additional) binder. During the drying phase of the composite material, starch completes a gelatinization process and may concentrate in the interface between support element and the top layer. The gypsum based support element may comprise a foaming agent to realize a foamed (light-weight) support element.

Preferably, the composite material comprises high-calcium fly ash (HCF), which fly ash comprises at least 20% by weight of calcium oxide, and, preferably, sulphur trioxide. Fly ash, in particular high-calcium fly ash, is an aluminosilicate material that could be used as (partial) replacement of traditional inert fillers, such as sand, gravel, or crushed stone (stone dust), which could lead to a less porous composite material, and (hence) to a significantly strengthened composite material. This will be in favour of the rigidity and durability of the support element, and hence of the panel as such.

Preferably, the composite material comprises at least one filler, preferably at least one inert mineral filler, such as calcium carbonate. The mineral filler content, if applied, is typically situated between 5% and 40%, preferably between 5% and 30%, by weight, of the composite material. The composite material may comprise one or more other additives chosen from the group consisting of: a colouring agent, siloxan, iron sulphate, potassium oxide, and aluminum oxide. Typically, the overall amount of this/these other additive(s) is lower than 10% by weight of the composite material.

The composite material preferably comprises natural particles, in particular natural fibers. The natural particles are preferably plant particles, in particular plant fibers; wood particles, in particular wood dust, wood fibers or wood chips; or animal particles, in particular animal fibers. Plant particles, in particular plant fibers, are particles, in particular fibers, initially produced by and obtained from plants. Wood particles, in particular wood fibers, are particles, in particular fibers, initially produced by and obtained from trees or woody plants. These particles (plant particles and wood particles) comprise cellulose and may therefore also be referred to as cellulose particles. Animal particles, in particular animal fibers, are particles, in particular fibers, initially produced by and obtained from animals. Typically an animal skin, in particular a leather animal skin, is very suitable to be used as fibers in the composite material. Advantages of plant and animal particles, in particular fibers, are that these particles are renewable, biodegradable, low cost, and typically light, which is favorable for the intended use. Although wood fibers have advantages over plant fibers, such as that wood fibers are relatively cheap and relatively easy to process, typically plant fibers are preferred over wood fibers for the intended use of the panels as floor panels since it has been found that plant fibers are considerably less sensitive for hygro-expansion (swelling due to moisture absorption). The moisture sensitivity is larger for wood fibers than for plant fibers, since the former contains a larger relative amount of hemicellulose which is the most hydrophilic polymer in the cell wall. Compared to composites with synthetic fibers, an undesired property of cellulose fiber based composites is their propensity to take up moisture, which could lead to swelling, dimensional instability, and potential degradation of mechanical properties. It has been found that the hydrophilicity of the fibers is due to the abundance of available hydroxyl groups in hemicellulose, in amorphous cellulose and at the surface of cellulose crystallites. Preferably, this moisture sensitivity is reduced as much as possible. For cellulose fiber based composites, this can be done by cross-linking of the cell wall polymers in the fibers, use of a stiff and hydrophobic binder, and use of a moisture barrier coating, which may also be realized by the binder as the binder may be configured to encapsulate and hence shield the cellulose fibers from the surrounding atmosphere. Preferably, the particles, more preferably the natural particles, dispersed in the binder are at least partially collectively and/or individually encapsulated by said binder. Since plant fibers have a relatively low hemicellulose content and a relatively high cellulose content, typically at least 60% by weight of cellulose and moreover a high degree of cellulose crystallinity, typically a cellulose crystallinity of at least 80% by weight of the total amount of cellulose, plant fibers are significantly less susceptible for moisture take up and therefore exhibit an improved dimensional stability (compared to wood fibers). Preferably, the natural particles comprises plant particles comprising less than 10% by weight of lignin. Preferably, the plant particles, in particular plant fibers are made of a plant material chosen from the group consisting of: hemp, grass, seagrass, elephant grass, bamboo, jute, flex, and/or mixtures of at least two of these materials. In case wood fibers are used, preferably spruce and/or eucalyptus and/or pine (kraft pulp) are used. Cork particles are considered as a specific example of wood particles and may be used as well in the support element. Alternatively, it is conceivable that the support element is entirely composed of cork, or that the support panel comprises a composite layer of ground (or shaved) cork bound by the binder.

Alternatively, or additionally, the composite material may comprises synthetic particles, in particular synthetic fibers, such as glass fibers, carbon fibers, or polymer fibers, in particular polyvinyl alcohol (PVA) based fibers.

Preferably, the natural and/or synthetic fibers incorporated in the binder are loose fibers. The natural and/or synthetic fibers incorporated in the binder are typically used to reinforce the support element and/or to improve the structural properties of the support element as such, and hence of the panel as such.

In a preferred embodiment, the support element has a density of at least 1000 kg/m3. The panel according to this embodiment benefits from the support element having a relatively high-density at least 1000 kg/m3, preferably at least 1100 kg/m3, more preferably at least 1200 kg/m3 and most preferably at least 1300 kg/m3, which is considerably higher than the density of MDF/HDF, a strong, waterproof, and substantially rigid panel is obtained. One could also refer to this relatively high-density fiberboard as a ultra-high-density fiberboard. Typically, such a high density can be achieved by compressing the support element and/or the natural fibers during the production process. It is technically possible to compress and densify wood fibers to 20% of its original thickness resulting in so called complete densification. This enables the panel being suitable for use in for example flooring or wall coverings. Another benefit of the panel according to the present invention is that due to the support element comprising a combination of natural fibers and at least one binder, and the support element having a density of at least 1000 kg/m3, the support element has a good dimension stability. The dimension stability of the support element enables the use of several types of top layers. Further, the support element being substantially dimensionally stable typically results in the panel as such being substantially dimensionally stable. The panel is further substantially waterproof and temperature stable, which characteristics can also be explained by the use of combination of natural fibers in a support element having a density of at least 1000 kg/m3. The panel according to the invention therefore benefits of material properties which are rather surprising for a wood based panel. The support element is a mainly wood-based support element. Despite that the binder might be a synthetic polymer, the support element is preferably substantially free of polymers as filler. The support element is preferably free of (thermoplastic) polymers as polyvinyl chloride (PVC), polyethylene (PE), high density polyethylene (HDPE), low density polyethylene (LDPE), polypropylene (PP), acrylonitrile butadiene styrene (ABS), polystyrene (PS) and/or polylactic acid (PLA).

As the (waterproof) ceramic or equivalent top layer is affixed to the waterproof support element, it is strongly preferred that the coefficients of moisture expansion (CME) of both layers are in the same order of magnitude, and a preferably aligned with each other. In case these CMEs of both layers mutually strongly differ delamination of damaging of the panels as such could easily occur. Expansion properties (linear expansion and contraction in the plane of the panel) and swelling properties (thickness swelling and shrinkage in a direction perpendicular to the plane of the panel) are commonly key parameters in the dimensional stability of the individual layers and of the panel according to the invention as such. Linear expansion values are typically considerably smaller than thickness swelling value. Particularly, linear expansion is considered as the control factor in qualifying the behaviour of the individual layers and of the panel as such when exposed to moisture. The hygroscopic linear expansion of the individual panel layers, in the plane of the panel, is of practical importance for using the panels to create a durably stable floor or wall covering.

The top layer is typically not, or practically not, susceptible for expansion or contraction due to moisture changes in the direct environment. Hence, the CME of the top layer is typically zero or very close to zero. It is therefore advantageous in case the support element has a linear moisture expansion coefficient of less than 0.015% per % moisture change of the support element. This means that the expansion of the support element in the plane of the panel is less than 0.15 mm per m length of the support element in case the moisture content of the support element is changing, typically increasing, with 1%. Preferably, the support element has a first linear moisture expansion coefficient, and wherein the top layer has second linear moisture expansion coefficient, wherein the difference between the first linear moisture expansion coefficient and the second linear moisture expansion coefficient is less than 0.015% per % moisture change. Preferably, the support element has a linear moisture contraction coefficient of less than 0.025% per % moisture change of the support element. This means that the contraction (shrinkage) of the support element in the plane of the panel is less than 0.25 mm per m length of the support element in case the moisture content of the support element is changing, typically decreasing, with 1%. Preferably, the support element has a first linear moisture contraction coefficient, and wherein the top layer has second linear moisture contraction coefficient, wherein the difference between the first linear moisture contraction coefficient and the second linear moisture contraction coefficient is less than 0.025% per % moisture change.

In a preferred embodiment, the support element has a thickness swelling coefficient of less than 0.6% per % moisture change of the support element. This means that the expansion of the support element, in a direction perpendicular to the plane of the panel, is less than 0.0006 mm per mm thickness of the support element in case the moisture content of the support element is changing, typically increasing, with 1%. Preferably, the support element has a first thickness swelling coefficient, and wherein the top layer has second thickness swelling coefficient, wherein the difference between the first thickness swelling coefficient and the second thickness swelling coefficient is less than 0.6% per % moisture change. Preferably, the support element has a thickness shrinkage coefficient of less than 0.5% per % moisture change of the support element. This means that the thickness reduction of the support element is less than 0.0005 mm per mm thickness of the support element in case the moisture content of the support element is changing, typically decreasing, with 1%. Preferably, the support element has a first thickness shrinkage coefficient, and wherein the top layer has a second thickness shrinkage coefficient, wherein the difference between the first thickness shrinkage coefficient and the second thickness shrinkage coefficient is less than 0.5% per % moisture change.

Both for the top layer and for the support element, the moisture expansion can be determined by applying the test described in ISO 10545.

The support element may be is at least partially foamed and/or may be at least partially solid. In case of an at least partially foamed wood based waterproof support element, the density of the support element will be relatively low, and typically smaller than 500 kg/m3. In case of an at least partially solid wood based waterproof support element, the density of the support element will be higher than 500 kg/m3, and is preferably at least 1000 kg/m3 as already indicated above.

As indicated above, preferably at least one pair of opposed side edges of the support element is provided with interconnecting coupling means for interconnecting adjacent panels. This enables easier constructing of a floor or wall covering of a plurality of panels according to the present invention. Partly because of the relatively high density of the support element, it is possible to provide the side edges of the support element with interconnecting coupling means. Non-limiting examples of possible interconnecting coupling means are described hereinafter. It is for example conceivable that the support element is provided with complementary coupling means, such as a tong and groove. However, it is also possible that the interconnecting coupling means are embodied as follows:

In the panel according to the invention, the interconnecting coupling means may include respectively a first and a second coupling profile at a respective first and second side edge of the pair of side edges, wherein the first coupling profile comprises:
an upward tongue,
at least one upward flank lying at a distance from the upward tongue,
an upward groove formed in between the upward tongue and the upward flank wherein the upward groove is adapted to receive at least a part of a downward tongue of a second coupling profile of another, identical panel, and
at least one first locking element, preferably provided at a distant side of the upward tongue facing away from the upward flank,

and wherein the second coupling profile comprises:
a first downward tongue,
at least one first downward flank lying at a distance from the downward tongue,
a first downward groove formed in between the downward tongue and the downward flank, wherein the downward groove is adapted to receive at least a part of an upward tongue of a first coupling profile of another, identical panel, and
at least one second locking element adapted for co-action with a first locking element of the other identical panel, said second locking element preferably being provided at the downward flank.

Preferably, the first coupling profile and the second coupling profile are configured such that the first and second coupling profiles of two identical panels can be coupled to each other by means of a lowering or vertical movement, which involves at least a part of the downward tongue of a first panel being inserted into the upward groove of the other identical panel, and wherein at least a part of the upward tongue of the other panel is inserted into the downward groove of the first panel. An inside of the upward tongue (facing the upward flank) and the inside of the downward tongue (facing the downward flank) may be in contact in coupled condition, to transfer forces between them, in particular from the upward tongue to the downward tongue. The insides of the tongues may be in contact at tongue contact surfaces, wherein the tongue contact surfaces may be inclined. The inclination may be such that a portion of the inside of the upward tongue is inclined towards the flank, such that a tangent line from the tongue contact surface intersects with the inner vertical plane above the tongue contact surface.

Alternatively the inclination may be such that a portion of the inside of the tongue is inclined away from the upward flank, such that a tangent line from the tongue contact surface intersects with the inner vertical plane below the tongue contact surface. These are closed groove and open groove systems respectively. Closed groove systems provide for an improved (drop-)locking, but are more difficult to couple, whereas open groove systems are easier to couple but do not provide the additional vertical locking of a closed groove system.

Furthermore, in the panel according to the invention, the panel may comprise at least one third coupling profile and at least one fourth coupling profile located respectively at a third panel edge and a fourth panel edge, wherein the third coupling profile comprises:
a sideward tongue extending in a direction substantially parallel to the upper side of the panel,
at least one second downward flank lying at a distance from the sideward tongue, and
a second downward groove formed between the sideward tongue and the second downward flank,

wherein the fourth coupling profile comprises:
a third groove configured for accommodating at least a part of the sideward tongue of the third coupling profile of a second identical panel, said third groove being defined by an upper lip and a lower lip, wherein said lower lip is provided with an upward locking element,

wherein the third coupling profile and the fourth coupling profile are configured such that the third and fourth coupling profiles of two identical panels can be coupled to each other by means of a turning movement, which involves at least a part of the sideward tongue of a first panel being inserted into the third groove of the other identical panel, and wherein at least a part of the upward locking element of the other panel is inserted into the second downward groove of the first panel.

Preferably, the panel comprises, at a first pair of opposed side edges, a first and a second coupling profile, wherein the first coupling profile and the second coupling profile are configured such that the first and second coupling profiles of two identical panels can be coupled to each other by means of a vertical movement, and wherein the panel comprises, at a second pair of opposed edges, a third coupling profile and a fourth coupling profile, wherein the third coupling profile and the fourth coupling profile are configured such that the third and fourth coupling profiles of two identical panels can be coupled to each other by means of a turning movement.

In a preferred embodiment the support element is larger than the decorative top layer. Typically the length and/or width of the support element is/are larger than the length and/or width of the top layer. Typically, each edge of the support element extends with respect to corresponding edge of the top layer, as seen from a top view. Overdimensioning of the support element allows the coupling profiles to be situated at a (lateral) distance from the top layer. This will facilitate the coupling of the panels during installation, and moreover, creates natural grout lines (and grout cavities) between top layers of adjacent panels. An exposed upper surface of the support element may be provided with a coating, such as a decorative coating or a primer for grout to be (optionally) applied on top of the exposed surface.

The support element preferably consists of a single material layer. This means that the support element is made of a sole material layer. Hence, the support element is a monolayer element and not a laminate. A benefit of the support consisting of a single material layer is that it is easier to produce compared to a multilayer product. Further, it may results in a more uniform product, which may contribute to the strength of the support element. Another benefit is that there is no risk of delamination of the support element as such, which may contribute to the durability of the support element, and thus to the durability of the panel.

Typically, the support element has a thickness between 2 to 10 millimeters, preferably between 2 and 6 millimeters, more preferably between 2 and 4 millimeters. It is experimentally found that the support element can provide sufficient support for any top layer when having a thickness between 2 and 10 millimeters. Due to the high density of the support element, the support element can be relatively thin when compared to prior art material, in particular prior art wood-based materials. This is beneficial as a relatively thin panel can be obtained. On the other hand, it also enables to apply a relatively thick top layer. This may in particular be beneficial if the support element is provided with a top layer comprising a ceramic material.

It is preferred that the support element comprises at least 10% by weight of the binder, preferably at least 20% by weight and more preferably at least 30% by weight. However, it is also conceivable that the support element comprises up to 40 or 45% by weight of binder. If the content of binder increases, also the hydrophilic character of the support element decreases. Hence, water permeation into the (vessels of) the natural fibers and water absorption is therefore reduced in case the content of binder is increased. The support element has than a more hydrophobic surface, resulting in a better water resistance. The content of binder in the support element is partly a measure for the density of the support element. The density is further for example partly dependent on the production process, where the applied pressure and/or temperature during production of the support element may influence the final density, and the physical and/or chemical bonding, mutually between the natural fibers and/or between the natural fibers and one or more additives. In addition to this, also the (type of) natural fibers may affect the density.

As already indicated above, in a further possible embodiment, the support element may have a density of at least 1100 kg/m3, preferably at least 1200 kg/m3 and more preferably at least 1300 kg/m3. It is for example also possible that the support element has a density between 1250 and 1400 kg/m3. Such embodiment having a relatively high density may provide a support element having a further improved mechanical properties, such as an improved mechanical strength. It is also found that an increased density corresponds to an increased inner bonding strength and an increased modulus of elasticity. The modulus of elasticity for a panel according to the present invention may for example be between 5 and 7.5 GPa for panels having a density between 1000 and 1400 kg/m3. As outlined above, the density of the support element can be influenced by several factors.

Preferably, the composite material comprises between 1% and 60%, in particular between 2% and 40%, by weight of cellulose particles. It is preferred that at least part of the cellulose particles, in particular wood fibers, is encapsulated by the binder. In this way, a relatively compact (internal) structure of the natural fibers and binder can be obtained. In a further preferred embodiment, substantially all natural fibers are encapsulated by the binder. When at least part of the natural fibers is encapsulated by the binder a denser internal structure of the support element is obtained. This may further contribute to the hydrophobic character of the support element. When at least part of the natural fibers is encapsulated by binder a more aligned inner structure of the natural fibers can be obtained.

In a possible embodiment, the panel may comprise at least one backing layer. If applied, the backing layer is preferably attached to the lower surface of the support element. The backing layer could be any suitable backing layer, such as cork, as known in the prior art. The backing layer may for example be a sound dampening layer.

Preferably, at least part of the natural fibers has a length smaller than 10 mm, preferably smaller than 5 mm, more preferably smaller than 2.5 mm, even more preferably smaller than 1 mm. Such relatively small natural fibers may enable that a relatively dense inner structure can be obtained. It may further enable that a relatively high percentage of natural fibers can be encapsulated by the binder. In a possible embodiment, the natural fibers may have an average length smaller than or equal to 1 millimeter. This is for example possible when the natural fibers have an initial density of 0.40 g/cm3. A non-limiting example is the use of natural fibers from populus and/or (grass fibers from) bamboo. Although bamboo is formally a grass, bamboo is considered as wood, and bamboo fibers are considered as natural fibers in the context of this patent document. Preferably, the natural fibers used in the support element comprises at least two different types of natural fibers, more preferably bamboo fibers and natural fibers made from another wood material, wherein it is in particularly preferred that this mixture of natural fibers comprises more bamboo fibers (in weight percentage) than other natural fibers (in weight percentage).

Preferably, the support element comprises at least 90 percent by weight (bonded) wood, in particular a mixture of natural fibers and (resin) binder. More preferably, the support element comprises approximately 95 percent by weight (bonded) wood, in particular a mixture of natural fibers and (resin) binder.

It is possible that the support element comprises at least one additive. Preferably, the support element comprises at most 10 percent by weight of additive(s). More preferably, the total amount of additives is approximately 5 percent by weight of the support element. With respect to the additive(s), various preferred embodiments have been described below. It is for example possible that a (coloured) pigment is added in order to adapt the colour of the support element. However, further non-limiting example of possible additives are a reinforcing agent, a thickening agent and/or an UV stabilizer. Preferably, the support element comprises at least one metal oxide chosen from the group consisting of: calcium oxide, magnesium oxide, zinc oxide, aluminum oxide. Preferably, the total amount of additives used in the support element comprises 10-20 percent by weight of metal oxide. Preferably, the support element comprises at least one non-metal oxide chosen from the group consisting of: silicon dioxide, boron oxide. Preferably, the total amount of additives used in the support element comprises 5-10 percent by weight of non-metal oxide. Preferably, the support element comprises at least one chloride comprising additive, in particular at least one chloride hydrate comprising additive, chosen from the group consisting of: hydrochloride, sodium chloride, calcium chloride, magnesium chloride, aluminum chloride. Preferably, the total amount of additives used in the support element comprises 1-2 percent by weight of at least one chloride comprising additive, in particular at least one chloride hydrate. Preferably, the support element comprises at least one sulfate comprising additive, in particular at least one sulfate hydrate comprising additive, chosen from the group consisting of: sodium sulfate, calcium sulfate, aluminum sulfate, magnesium sulfate Preferably, the total amount of additives used in the support element comprises 1-2 percent by weight of at least one sulfate comprising additive, in particular at least one sulfate hydrate. Preferably, the support element comprises at least one phosphate comprising additive, in particular at least one phosphate hydrate comprising additive, chosen from the group consisting of: calcium phosphate, magnesium phosphate, zinc phosphate, aluminum phosphate. Preferably, the total amount of additives used in the support element comprises 1-2 percent by weight of at least one phosphate comprising additive, in particular at least one phosphate hydrate. Preferably, the support element comprises at least one weak acid, in particular a weak acid chosen from the group consisting of: acetic acid, oxalic acid, citric acid, maleic acid, phosphoric acid, carbonic acid. Preferably, the total amount of additives used in the support element comprises 5-10 percent by weight of at least one weak acid. Preferably, the support element comprises at least one strong acid, in particular a strong acid chosen from the group consisting of: hydrochloric acid, sulfuric acid, nitric acid. Preferably, the total amount of additives used in the support element comprises 5-10 percent by weight of at least one strong acid. The support element preferably comprises at least two of the abovementioned additives, and more preferably all of the abovementioned additives. One could say that the (at least two) abovementioned additives applied together represent a binder (binding material) of the support element. This binder is typically present in an amount of 2-6 percent by weight of the support element, more preferably approximately 3 percent by weight of the support element. Preferably, the support element comprises magnesium oxide and/or magnesium hydroxide. Preferably, the total amount of additives used in the support element comprises an amount of 20-60 percent by weight, more preferably approximately 40 percent by weight, of magnesium oxide and/or magnesium hydroxide. Typically the support element comprises an amount of 1-4 percent by weight, more preferably approximately 2 percent by weight, of magnesium oxide and/or magnesium hydroxide. It has been found that the combination (mixture) of additives, combined with plant fibers and/or wood fibers (and/or wood dust), could lead to a waterproof, cellulose-based (and environmental-friendly) support element.

Preferably, the support element has a breathability, and is more preferably suitable to absorb carbon dioxide and/or sulfur dioxide from the air. This breathability, in particular absorption capacity, can and typically will lead to desired chemical reaction on and within the board, wherein typically a shield film or coating is created, and which typically improves the strength of the support element.

Preferably, the support element is made natural wood (or grass), such as bamboo, which is crushed to dust, mixed with (food-grade) additives, pressed into the shape of a support element, and subsequently crystallized, solidified, coagulated, and baked at elevated temperature, typically 200 degrees Celsius for about one hour.

As the main raw material of the support element is preferably wood powder obtained from renewable forests, there are no special restrictions on the types of wood to be used.

In a preferred embodiment of the panel according to the present invention, the top layer comprises ceramic material, or any other material chosen from the group consisting of: stone, concrete, mineral porcelain, glass, mosaic, granite, limestone and marble. It is in particular preferred if the top layer is a ceramic layer. The use of a combination of a support element according to the present invention and a top layer comprises a ceramic material, or the top layer being a ceramic material, is mainly possible due to the relatively high dimension stability of the support element. The top layer may for example be a ceramic tile. This embodiment may in particular be interesting in case the support element is provided with interconnecting coupling means. Providing a floor (or wall) covering of the ceramic tiled can than easily be achieved by interconnecting the panels according to the present invention. It is rather difficult, and often even impossible to provide profiling directly on ceramic since, as profiling may chip the ceramic material and give rise to breakages and/or cracks.

The top layer may for example have a thickness between 2 and 20 millimeters, preferably between 2.5 and 10 millimeters, more preferably between 3 and 6 millimeters. It is conceivable that the thickness of the support element is smaller than the thickness of the top layer. Due to the support element having a relatively high density, the support element is sufficiently strong to enable the use of top layer with a thickness which is larger than the thickness of support element itself. The latter even applies when a top layer comprising a ceramic material is applied.

The support element and the top layer may be mutually affixed via an adhesive layer. It is for example possible that the top layer, which may be a ceramic tile, is glued onto the upper surface of the support element. Preferably, an adhesive is used which loses its adhesion at a predetermined temperature, more preferably an adhesive which loses its adhesion between 80 and 120 degrees Celsius. Such adhesive would allow to separate the support element and the top layer such that both parts can be recycled separately. In addition, the use of such adhesive allows an exchange of a damaged top layer by (locally) heating the panel, typically to a temperature between 80 and 120 degrees Celsius, such that the top layer can be exchanged without having to remove multiple panels. Preferably, the adhesive layer is flexible layer configured to withstand (linear) expansion and contraction differences between the support element and the top layer. Preferably, a hot melt adhesive (thermoplastic adhesive) is used. The invention also relates to the use of an adhesive, in particular a hot melt adhesive, which loses its adhesion at least partially and/or has a reduced bond strength, at an elevated temperature, preferably between 80 and 120 degrees Celsius, for gluing a decorative top layer, either directly of indirectly, onto a support element to construct a decorative panel, in particular a decorative panel according to the invention. Such an adhesive facilitates delamination of the panel for recycling purposes.

Some of the possible base materials of suitable adhesives include the following:
Ethylene-vinyl acetate (EVA) copolymers, low-performance, the low-cost and most common hot melt adhesive They provide sufficient strength between 15 and 50° C. but are limited to use below 60-80° C. and have low creep resistance under load. The vinyl acetate monomer content is preferably about 18-29 percent by weight of the polymer. High amounts of tackifiers and waxes are often used; an example composition is 30-40% of EVA copolymer (provides strength and toughness), 30-40% of tackifier resin (improves wetting and tack), 20-30% of wax (usually paraffin-based; reduces viscosity, alters setting speed, reduces cost), and 0.5-1.0% of stabilizers. Fillers can be added Lower molecular weight chains provide lower melt viscosity, better wetting, and better adhesion to porous surfaces. Higher molecular weights provide better cohesion at elevated temperatures and better low-temperature behavior. Increased ratio of vinyl acetate lowers the crystallinity of the material, improves optical clarity, flexibility and toughness, and worsens resistance to solvents. EVA can be crosslinked by, e.g., peroxides, yielding a thermosetting material. EVAs can be compounded with aromatic hydrocarbon resins. Grafting butadiene to EVA improves its adhesion. Its dielectric properties are poor due to high content of polar groups, the dielectric loss is moderately high. Polypropylene HMAs are a better choice for high-frequency electronics. EVAs are optically clearer and more gas and vapor permeable than polyolefins.
   Ethylene-acrylate copolymers have lower glass transition temperature and higher adhesion even to difficult substrates than EVA. Better thermal resistance, increased adhesion to metals and glass. Suitable for low temperature use. Ethylene-vinylacetate-maleic anhydride and ethylene-acrylate-maleic anhydride terpolymers offer very high performance. Examples are ethylene n-butyl acrylate (EnBA), ethylene-acrylic acid (EAA) and ethylene-ethyl acetate (EEA).
Polyolefins (PO) (polyethylene (usually LDPE but also HDPE, which has a higher melting point and better temperature resistance), atactic polypropylene (PP or APP), polybutene-1, oxidized polyethylene, etc.), low-performance, for difficult-to-bond plastics. Very good adhesion to polypropylene, good moisture barrier, chemical resistance against polar solvents and solutions of acids, bases, and alcohols. Longer open time in comparison with EVA and polyamides. Polyolefins have low surface energy and provide good wetting of most metals and polymers. Metallocene-catalyst-synthesised polyolefins have a narrow distribution of molecular weight and correspondingly narrow melting temperature range. Due to the relatively high crystallinity, polyethylene-based glues tend to be opaque and, depending on additives, white or yellowish. Polyethylene hot melts have high pot life stability, are not prone to charring, and are suitable for moderate temperature ranges and on porous non-flexible substrates. Nitrogen or carbon dioxide can be introduced into the melt, forming a foam which increases spreading and open time and decreases transfer of heat to the substrate, allowing use of more heat-sensitive substrates; polyethylene-based HMAs are usually used. PE and APP are usually used on their own or with just a small amount of tackifiers (usually hydrocarbons) and waxes (usually paraffins or microcrystalline waxes, for lower cost, improved anti-blocking, and altered open time and softening temperature). The molecular weight of the polymer is usually lower. Lower molecular weights provide better low-temperature performance and higher flexibility, higher molecular weights increase the seal strength, hot tack, and melt viscosity.
   Polybutene-1 and its copolymers are soft and flexible, tough, partially crystalline, and slowly crystallizing with long open times. The low temperature of recrystallization allows for stress release during formation of the bond. Good bonding to nonpolar surfaces, worse bonding to polar ones. Good for rubber substrates, and can be formulated as pressure-sensitive.
   Amorphous polyolefin (APO/APAO) polymers are compatible with many solvents, tackifiers, waxes, and polymers; they find wide use in many adhesive applications. APO hot melts have good fuel and acid resistance, moderate heat resistance, are tacky, soft and flexible, have good adhesion and longer open times than crystalline polyolefins. APOs tend to have lower melt viscosity, better adhesion, longer open times and slow set times than comparable EVAs. Some APOs can be used alone, but often they are compounded with tackifiers, waxes, and plasticizers (e.g., mineral oil, poly-butene oil). Examples of APOs include amorphous (atactic) propylene (APP), amorphous propylene/ethylene (APE), amorphous propylene/butene (APB), amorphous propylene/hexene (APH), amorphous propylene/ethylene/butene. APP is harder than APE, which is harder than APB, which is harder than APH, in accordance with decreasing crystallinity. APOs show relatively low cohesion, the entangled polymer chains have fairly high degree of freedom of movement. Under mechanical load, most of the strain is dissipated by elongation and disentanglement of polymer chains, and only a small fraction reaches the adhesive-substrate interface. Cohesive failure is therefore a more common failure mode of APOs.
Polyamides and polyesters, high-performance
   Polyamides (PA), high-performance, for severe environments; high-temperature glues; typically applied at over 200° C., but can degrade and char during processing. In molten state can somewhat degrade by atmospheric oxygen. High application temperature. High range of service temperatures, generally showing adequate bonding from −40 to 70° C.; some compositions allow operation to 185° C. if they do not have to carry load. Resistant to plasticizers, therefore suitable for gluing polyvinyl chloride; only polyamides derived from secondary diamines however provide a satisfying bond. Resistant to oils and gasoline. Good adhesion to many substrates such as metal, wood, vinyl, ABS, and treated polyethylene and polypropylene. Three groups are employed, with low, intermediate, and high molecular weight; the low MW ones are low-temperature melting and easy to apply, but have lower tensile strength, lower tensile-shear strength, and lower elongation than the high-MW ones. The high-MW ones require sophisticated extruders and are used as high-performance structural adhesives. The presence of hydrogen bonds between the polymer chains gives polyamides a high strength at even low molecular weights, in comparison with other polymers. Hydrogen bonds also provide retention of most of the adhesive strength up almost to the melting point; however they also make the material more susceptible to permeation of moisture in comparison with polyesters. Can be formulated as soft and tacky or as hard and rigid. Niche applications, together with polyesters taking less than 10% of total volume of hot melt adhesives market. Absorption of moisture may lead to foaming during application as water evaporates during melting, leaving voids in the adhesive layer which degrade mechanical strength. Polyamide HMAs are usually composed of a dimer acid with often two or more different diamines. The dimer acid usually presents 60-80% of the total polyamide mass, and provides amorphous nonpolar character. Linear aliphatic amines such as ethylene diamine and hexamethylene diamine, provide hardness and strength. Longer chain amines such as dimer amine, reduce the amount of hydrogen bonds per volume of material, resulting in lower stiffness. Polyether diamines provide good low-temperature flexibility. Piperazine and similar diamines also reduce the number of hydrogen bonds. Only polyamides based on piperazine and similar secondary amines form satisfactory bond with polyvinyl chloride; primary amines form stronger hydrogen bonds within the adhesive, secondary amines can act only as proton acceptors, don't form hydrogen bonds within the polyamide, and are therefore free to form weaker bonds with vinyl, probably with the hydrogen atom adjacent to the chlorine.
   Polyesters, similar to the ones used for synthetic fibers. High application temperature. Synthetized from a diol and a dicarboxylic acid. The length of the diol chain has major influence to the material's properties; with increasing diol chain length the melting point increases, the crystallization rate increases, and the degree of crystallization decreases. Both the diol and acid influence the melting point. In comparison with similar polyamides, due to absence of hydrogen bonds, polyesters have lower strength and melting point, but are much more resistant to moisture, though still susceptible. In other parameters, and in applications where these factors do not play a role, polyesters and polyamides are very similar. Polyesters are suitable for bonding fabrics. They can be used on their own, or blended with large amounts of additives. They are used where high tensile strength and high temperature resistance are needed. Most polyester hot melt adhesives have high degree of crystallinity. Niche applications, together with polyamides taking less than 10% of total volume of hot melt adhesives market. Water-dispersible amorphous polymers, modified by addition of sodium sulfonate groups for dispersability, were however developed for repulpable adhesives. Polyesters are often highly crystalline, leading to narrow melting temperature range, which is advantageous for high-speed bonding.
Polyurethanes
   Thermoplastic polyurethane (TPU) offer good adhesion to different surfaces due to presence of polar groups. Their low glass transition temperature provides flexibility at low temperatures. They are highly elastic and soft, with wide possible crystallization and melting point ranges. Polyurethanes consist of long linear chains with flexible, soft segments (diisocyanate-coupled low-melting polyester or polyether chains) alternating with rigid segments (diurethane bridges resulting from diisocyanate reacting with a small-molecule glycol chain extender). The rigid segments form hydrogen bonds with rigid segments of other molecules. Higher ratio of soft to hard segments provides better flexibility, elongation, and low-temperature performance, but also lower hardness, modulus, and abrasion resistance. The bonding temperature is lower than with most other HMAs, only about 50-70° C., when the adhesive behaves as a soft rubber acting as a pressure-sensitive adhesive. The surface wetting in this amorphous state is good, and on cooling the polymer crystallizes, forming a strong flexible bond with high cohesion. Choice of a proper diisocyanate and polyol combination allows tailoring the polyurethane properties; they can be used on their own or blended with a plasticizer. Polyurethanes are compatible with most common plasticizers, and many resins.
   Polyurethanes (PUR), or reactive urethanes, for high temperatures and high flexibility. Solidification can be rapid or extended in range of several minutes; secondary curing with atmospheric or substrate moisture then continues for several hours, forming cross-links in the polymer. Excellent resistance to solvents and chemicals. Low application temperature, suitable for heat-sensitive substrates. Heat-resistant after curing, with service temperatures generally from −30° C. to +150° C. Ink-solvent resistant. Usually based on prepolymers made of polyols and methylene diphenyl diisocyanate (MDI) or other diisocyanate, with small amount of free isocyanate groups; these groups when subjected to moisture react and cross-link. The uncured solidified “green” strength tends to be low than non-reactive HMAs, mechanical strength develops with curing. Green strength can be improved by blending the prepolymer with other polymers. Since PUR is highly flexible and has a broad thermal setting range, PUR is perfect for bonding difficult substrates.
Styrene block copolymers (SBC), also called styrene copolymer adhesives and rubber-based adhesives, have good low-temperature flexibility, high elongation, and high heat resistance. Frequently used in pressure-sensitive adhesive applications, where the composition retains tack even when solidified; however non-pressure-sensitive formulations are also used. High heat resistance, good low-temperature flexibility. Lower strength than polyesters. They usually have A-B-A structure, with an elastic rubber segment between two rigid plastic endblocks. High-strength film formers as standalone, increase cohesion and viscosity as an additive. Water-resistant, soluble in some organic solvents; cross-linking improves solvent resistance. Resins associating with endblocks (cumarone-indene, α-methyl styrene, vinyl toluene, aromatic hydrocarbons, etc.) improve adhesion and alter viscosity. Resins associating to the midblocks (aliphatic olefins, rosin esters, polyterpenes, terpene phenolics) improve adhesion, processing and pressure-sensitive properties. Addition of plasticizers reduces cost, improves pressure-sensitive tack, decrease melt viscosity, decrease hardness, and improve low-temperature flexibility. The A-B-A structure promotes a phase separation of the polymer, binding together the endblocks, with the central elastic parts acting as cross-links; SBCs do not require additional cross-linking.
   Styrene-butadiene-styrene (SBS), used in high-strength PSA applications.
   Styrene-isoprene-styrene (SIS), used in low-viscosity high-tack PSA applications.
   Styrene-ethylene/butylene-styrene (SEBS), used in low self-adhering non-woven applications.
   Styrene-ethylene/propylene (SEP)
Polycaprolactone with soy protein, using coconut oil as plasticizer, a biodegradable hot-melt adhesive
Polycarbonates
Fluoropolymers, with tackifiers and ethylene copolymer with polar groups
Silicone rubbers, undergo cross-linking after solidification, form durable flexible UV and weather resistant silicone sealant
Thermoplastic elastomers
Polypyrrole (PPY), a conductive polymer, for intrinsically conducting hot melt adhesives (ICHMAs), used for EMI shielding. EVA compounded with 0.1-0.5 wt. % PPY are strongly absorbing in near infrared, allowing use as near-infrared activated adhesives.
various other copolymers

The adhesive may be enriched with one or more additives. Examples of such additives include the following:
tackifying resins (e.g., rosins and their derivates, terpenes and modified terpenes, aliphatic, cycloaliphatic and aromatic resins (C5 aliphatic resins, C9 aromatic resins, and C5/C9 aliphatic/aromatic resins), hydrogenated hydrocarbon resins, and their mixtures, terpene-phenol resins (TPR, used often with EVAs)), up to about 40%. Tackifiers tend to have low molecular weight, and glass transition and softening temperature above room temperature, providing them with suitable viscoelastic properties. Tackifiers frequently present most of both weight percentage and cost of the hot-melt adhesive.
waxes, e.g., microcrystalline waxes, fatty amide waxes or oxidized Fischer-Tropsch waxes; increase the setting rate. One of the key components of formulations, waxes lower the melt viscosity and can improve bond strength and temperature resistance.
plasticizers (e.g., benzoates such as 1,4-cyclohexane dimethanol dibenzoate, glyceryl tribenzoate, or pentaerythritol tetrabenzoate, phthalates, paraffin oils, polyisobutylene, chlorinated paraffins, etc.)
antioxidants and stabilizers (e.g., hindered phenols, BHT, phosphites, phosphates, hindered aromatic amines); added in small amounts (<1%), not influencing physical properties. These compounds protect the material from degradation both during service life, compounding and in molten state during application. Stabilizers based on functionalized silicones have improved resistance to extraction and outgassing.
UV stabilizers protect the material against degradation by ultraviolet radiation
pigments and dyes, glitter
biocides for hindering bacterial growth
flame retardants
antistatic agents
fillers, for reducing cost, adding bulk, improving cohesive strength (forming an aggregate-matrix composite material) and altering properties; e.g., calcium carbonate, barium sulfate, talc, silica, carbon black, clays (e.g., kaolin). Fugitive glues and pressure-sensitive adhesives are available in hot-melt form. With a tack-like consistency, PSA are bonded through the application of pressure at room temperature. Additives and polymers containing unsaturated bonds are highly prone to autoxidation. Examples include rosin-based additives. Antioxidants can be used for suppressing this aging mechanism. Addition of ferromagnetic particles, hygroscopic water-retaining materials, or other materials can yield a hot melt adhesive which can be activated by microwave heating. Addition of electrically conductive particles can yield conductive hot-melt formulations.

In a preferred embodiment of the panel, the panel comprises at least one intermediate substrate layer situated in between the support element and the top layer. This intermediate substrate layer can be rigid, semi-rigid, or flexible. At least one intermediate substrate layer preferably comprises at least one material of the group of materials consisting of: wood, in particular MDF or HDF; a polymer, in particular PVC, PE, PP, or PU; a mineral, such as MgO, or mixtures thereof, such as a mineral-plastic composite. The thickness of this intermediate substrate layer is typically situated in between 1 and 6 mm. The intermediate substrate layer is preferably adhered to the support element and the top layer by using an adhesive (glue).

In a preferred embodiment, the support element comprises at least one reinforcing layer embedded in said composite material, wherein the reinforcing layer is preferably a glass-fiber layer. It is imaginable that at least two separate reinforcing layers are embedded in the composite material. This will typically (further) increase bending stiffness of the support element. Here, the at least two reinforcing layers are preferably situated at a distance from a center plane of the support element, wherein, more preferably, a first one of the at least two separate reinforcing layers is situated between a center plane and the top surface of the support element, and a second one of the at least two separate reinforcing layers being situated between the center plane and the lower surface of the support element. Preferably, the one or more reinforcing layers are selected from the group consisting of: a glass fiber cloth, a glass fiber non-woven, and a glass fiber fabric.

The invention also relates to a panel for constructing a floor or wall covering, comprising at least one substantially flat support element comprising: an upper surface, a lower surface, a first pair of opposed side edges and a second pair of opposed side edges, and at least one decorative top layer which is affixed to the upper surface of the support element, wherein the support element comprises lignocellulose fibers and at least one binder, and wherein the support element has a density of at least 1000 kg/m3. The same preferred embodiment as described above are possible in combination with the support element comprising lignocellulose fibers and at least one binder. When it is referred to lignocellulose fibers natural fibers are meant. The lignocellulose can be both woody and/or nonwoody (for example plant like). Further non-limiting example of possible natural fibers which can be used within the present invention are bamboo, straw and/or plants.

The invention also relates to support element for use in a panel according to any of the previous claims. The invention further relates to a system for constructing a floor or wall covering comprising a plurality of panels according to the present invention. This plurality of panels could possibly be interconnected if interconnecting coupling means are applied.

The invention also relates to a method of manufacturing a panel for constructing a floor or wall covering, in particular a panel according to the present invention as described above comprising the steps:
a) providing (a plurality of) natural particles, in particular plant fibers, wood fibers or animal fibers,
b) mixing of the natural particles with at least one binder,
c) hot pressing of the mixture of natural particles, and binder at a temperature of at least 120 degrees Celsius, such that a substantially flat support element having a density of at least 1000 kg/m3 is obtained, and
d) optionally attaching at least one decorative top layer to the support element.

The panel obtained via this method experiences the benefits as outlined above. The method according to the present invention is typically applied at atmospheric pressure. The support element manufactured via the method is typically a single material layer. As indicated above, herewith a monolayer material and not a laminate is meant. The steps a)-d) of the method are typically subsequent steps. Typically, curing of the mixture of natural fibers and binder is achieved by the hot pressing step of step c). However, it is conceivable that an additional (after) curing step is applied.

Preferably, step c) of the method is performed at at least 150 degrees Celsius. This temperature can ensure that sufficient bonding between the natural fibers and the binder will be realized. Further, step c) is preferably performed for at least 5 minutes, preferably at least 7.5 minutes. It is experimentally found that performing step c) at at least 150 degrees Celsius and/or for at least 5 minutes, and preferably at least 7.5 minutes a desired high density can typically be obtained. It must be remarked that the optimal temperature, pressure and duration of the hot pressing step is in particular dependent on (desired) thickness of the support element. It is possible that at least one pair of opposed side edges is provided with interconnecting coupling means for interconnecting adjacent panels. This step could for example be performed prior to of after step d).

Preferably, the binder is a phenolic resin. The binder may in particular be a resol-type phenolic resin. A further non-limiting example is the binder being a phenol-formaldehyde resin having a formaldehyde to phenol ratio which is at least 1. Further, the binder may have a solid content between 30 and 70%, preferably between 40 and 60%, more preferably between 45 and 55%. Typically, the binder has a viscosity between 10 and 100 mPa s, in particular between 20 and 80 mPa/s, more in particular between 25 and 40 mPa s at 25 degrees Celsius. In a preferred embodiment, the mixture of natural fibers and binder has a content of binder which is at least 10% by weight, preferably at least 20% by weight and more preferably at least 30% by weight. It is also conceivable that the mixture has as content of binder up to 40 or 45% by weight. Hot pressing of the mixture of natural fibers and binder of step c), may also be performed such that a substantially flat support element having a density of at least 1100 kg/m3 is obtained, preferably at least 1200 kg/m3 and more preferably at least 1300 kg/m3. Benefits of said possible binder are described in relation to the panel according to the present invention and also apply to the method of manufacturing a panel. During step c), the mixture of natural fibers and binder is preferably pressed by a, typically hydraulic, press machine configured to exert a weight of more than 1000 tons (1.000.000 kg), preferably a weight of 12000 tons (1.200.000 kg).

The natural fibers provided preferably have a moisture content between 5 and 20% by weight, preferably between 7.5 and 15% by weight, and more preferably between 10 and 12% by weight. It is experimentally found that such moisture content does not negatively affect the production process. Preferably, at least part of the natural fibers has a length smaller than 5 mm, preferably smaller than 2.5 mm, more preferably smaller than 1 mm. It is beneficial to use relatively small natural fibers in order to be able to achieve a relatively high desired density.

It is conceivable that at least one additive is added during or after step b). It is for example possible that a (coloured) pigment is added in order to adapt the colour of the support element. However, further non-limiting example of possible additives are a reinforcing agent, a thickening agent and/or an UV stabilizer. The top layer may comprises ceramic and/or stone material. It is further possible that the support element and the top layer are mutually affixed via an adhesive layer. Preferably, an adhesive is used which loses its adhesion at a predetermined temperature, more preferably an adhesive which loses its adhesion between 80 and 120 degrees Celsius.

Preferably, at least part of the natural particles, in particular plant fibers, and/or wood fibers and/or animal fibers, provided at step a) have a moisture content between 5 and 20% by weight, preferably between 7.5 and 15% by weight, and more preferably between 10 and 12% by weight. It is possible that during step b) at least part of the natural particles are sprayed with binder. The binder could for example be air sprayed. This may result in a good distribution of binder with respect to the natural particles. Preferably, at least part of the mixture of natural particles and binder is conditioned prior to step c) such that the moisture content is 1 to 6% by weight, in particular 2 to 5% by weight, and more in particular 3 to 4% by weight. Such relatively low moisture content may positively affect the production speed and it may positively to contribute to the binding ability between the natural particles and the binders.

Various embodiments of the panel and the support element according to the invention are set out in the non-limitative set of clauses presented below:

1. Panel for constructing a floor or wall covering, comprising:
at least one substantially flat support element comprising: an upper surface, a lower surface, a first pair of opposed side edges and a second pair of opposed side edges, wherein the support element is waterproof and is at least partially made of cellulose, such as wood, and
at least one decorative top layer which is affixed, either directly or indirectly, to the upper surface of the support element, wherein the top layer is at least partially made of at least one material chosen from the group consisting of: ceramic, stone, concrete, mineral porcelain, glass, mosaic, granite, limestone and marble.

2. Panel according to clause 1, wherein the support element has a linear moisture expansion coefficient of less than 0.015% per % moisture change of the support element.

3. Panel according to clause 1 or 2, wherein the support element has a first linear moisture expansion coefficient, and wherein the top layer has second linear moisture expansion coefficient, wherein the difference between the first linear moisture expansion coefficient and the second linear moisture expansion coefficient is less than 0.015% per % moisture change.

4. Panel according to one of the previous clauses, wherein the support element has a linear moisture contraction coefficient of less than 0.025% per % moisture change of the support element.

5. Panel according to one of the previous clauses, wherein the support element has a first linear moisture contraction coefficient, and wherein the top layer has second linear moisture contraction coefficient, wherein the difference between the first linear moisture contraction coefficient and the second linear moisture contraction coefficient is less than 0.025% per % moisture change.

6. Panel according to one of the previous clauses, wherein the support element has a thickness swelling coefficient of less than 0.6% per % moisture change of the support element.

7. Panel according to one of the previous clauses, wherein the support element has a first thickness swelling coefficient, and wherein the top layer has second thickness swelling coefficient, wherein the difference between the first thickness swelling coefficient and the second thickness swelling coefficient is less than 0.6% per % moisture change.

8. Panel according to one of the previous clauses, wherein the support element has a thickness shrinkage coefficient of less than 0.5% per % moisture change of the support element.

9. Panel according to one of the previous clauses, wherein the support element has a first thickness shrinkage coefficient, and wherein the top layer has a second thickness shrinkage coefficient, wherein the difference between the first thickness shrinkage coefficient and the second thickness shrinkage coefficient is less than 0.5% per % moisture change.

10. Panel according to one of the previous clauses, wherein the support element is at least partially foamed.

11. Panel according to one of the previous clauses, wherein the support element is at least partially solid.

12. Panel according to one of the previous clauses, wherein the support element has a density of at least 1000 kg/m3, preferably at least 1100 kg/m3, more preferably at least 1200 kg/m3 and most preferably at least 1300 kg/m3.

13. Panel according to one of the previous clauses, wherein the support element comprises wood fibers and at least one binder for binding the wood fibers.

14. Panel according to clause 13, wherein the wood fibers are at least partially encapsulated by said binder.

15. Panel according to clause 13 or clause 14, wherein the binder is a phenolic resin.

16. Panel according to clause 15, wherein the binder is a resol-type phenolic resin.

17. Panel according to any of the clauses 13-16, wherein the binder is a phenol-formaldehyde resin having a formaldehyde to phenol ratio which is at least 1.

18. Panel according to any of the previous clauses, wherein at least part of the wood fibers has a length smaller than 5 mm, preferably smaller than 2.5 mm, more preferably smaller than 1 mm.

19. Panel according to any of the previous clauses, wherein the support element consists of a single material layer.

20. Panel according to any of the previous clauses, wherein the support element has a thickness between 2 and 10 mm, preferably between 2 and 6 mm.

21. Panel according to any of the previous clauses, wherein the support element comprises at least 10% by weight of the binder, preferably at least 20% by weight and more preferably at least 30% by weight.

22. Panel according to one of the previous clauses, wherein at least one pair of opposed side edges is provided with interconnecting coupling profiles for interconnecting adjacent panels.

23. Panel according to claim 22, wherein the panel comprises, at a first pair of opposed side edges, a first and a second coupling profile, wherein the first coupling profile and the second coupling profile are configured such that the first and second coupling profiles of two identical panels can be coupled to each other by means of a vertical movement, and wherein the panel comprises, at a second pair of opposed edges, a third coupling profile and a fourth coupling profile, wherein the third coupling profile and the fourth coupling profile are configured such that the third and fourth coupling profiles of two identical panels can be coupled to each other by means of a turning movement.

24. Panel according to one of the previous clauses, wherein the support element is larger than the decorative top layer.

25. Panel according to clause 23 and 24, wherein the coupling profiles are situated at a distance from the top layer.

26. Panel according to one of the previous clauses, wherein an exposed upper surface of the support element is provided with a coating.

27. Panel according to any of the previous clauses, wherein the support element and the top layer are mutually affixed via an adhesive layer.

28. Panel according to clause 27, wherein the adhesive layer is flexible layer configured to withstand expansion differences between the support element and the top layer.

29. Panel according to clause 27 or 28, wherein the adhesive layer is a hot melt adhesive layer.

30. Panel according to any of the previous clauses, wherein the top layer has a thickness between 2 and 20 mm, preferably between 2.5 and 10 mm, more preferably between 3 and 6 mm.

31. Panel according to any of the previous clauses, wherein the panel comprises at least one waterproof backing layer affixed to a lower side of the support element.

32. Panel according to any of the previous clauses, wherein the panel comprises at least one intermediate substrate layer situated in between the support element and the top layer.

33. Panel according to clause 32, wherein the intermediate substrate layer comprises at least one material of the group of materials consisting of: wood, in particular MDF or HDF; a polymer, in particular PVC, PE, PP, or PU; a mineral, such as MgO, or a mixture thereof, such as a mineral-plastic composite.

34. Panel according to one of the previous clauses, wherein the support element is at least partially made of a composite material, which composite material comprises:
at least one binder selected from the group consisting of: phenolic resin and magnesium oxide based cement and calcium oxide based cement;
cellulose particles, in particular cellulose fibers, dispersed in said binder; and
less than 20% by weight of thermoplastic material,

35. Panel according to clause 34, wherein the composite material is free of thermoplastic material.

36. Panel according to any of the previous clauses 34-35, wherein the composite material comprises magnesium oxide, magnesium chloride and water.

37. Panel according to any of the previous clauses, wherein the composite material comprises calcium oxide, and less than 2%, preferably less than 0.9%, more preferably less than 0.6% by weight of sodium oxide.

38. Panel according to any of the previous clauses, wherein the composite material comprises sand, in particular quartz sand.

39. Panel according to any of the previous clauses, wherein the composite material comprises high-calcium fly ash (HCF), which fly ash comprises at least 20% by weight of calcium oxide, and, preferably, sulphur trioxide.

40. Panel according to any of the previous clauses, wherein the cellulose particles, in particular cellulose fibers, are at least partially encapsulated by said binder.

41. Panel according to any of the previous clauses, wherein the cellulose particles comprises wood flour and/or wood fibers.

42. Panel according to any of the previous clauses, wherein the cellulose particles comprises plant fibers, in particular bamboo and/or hemp fibers.

43. Panel according to any of the previous clauses, wherein the composite material comprises between 1% and 50%, in particular between 2% and 40%, by weight of cellulose particles.

44. Panel according to any of the previous clauses, wherein the composite material comprises at least one mineral filler, such as calcium carbonate.

45. Panel according to any of the previous clauses, wherein the panel comprises at least one reinforcing layer embedded in said support element, wherein the reinforcing layer is preferably a glass-fiber layer.

46. Support element for use in a panel according to any of the previous clauses.

47. System for constructing a floor or wall covering comprises a plurality of panels according to any of clauses 1-45.

48. Method of manufacturing a panel for constructing a floor or wall covering, in particular a panel according to any of clauses 1-45, comprising the steps:

a) providing a quantity of cellulose particles, in particular wood fibers,

b) mixing of the cellulose particles, in particular wood fibers, with at least one binder,

c) hot pressing of the mixture of cellulose particles, in particular wood fibers, and binder at a temperature of at least 120 degrees Celsius, such that a substantially flat support element having a density of at least 1000 kg/m3 is obtained, and

d) attaching at least one decorative top layer to the support element.

49. Method according to clause 48, wherein step c) is performed at at least 150 degrees Celsius.

50. Method according to any of clauses 48-49, wherein step c) is performed for at least 5 minutes, preferably at least 7.5 minutes.

51. Method according to any of clauses 48-50, comprising the step of: providing at least one pair of opposed side edges of the support element with interconnecting coupling means for interconnecting adjacent panels.

52. Method according to any of clauses 48-51, wherein the binder is a phenolic resin, in particular a resol-type phenolic resin.

53. Method according to any of clauses 48-52, wherein the binder has a solid content between 30 and 70%, preferably between 40 and 60%, more preferably between 45 and 55%.

54. Method according to any of clauses 48-53, wherein the binder has a viscosity between 10 and 100 mPa·s, in particular between 20 and 80 mPa·s, more in particular between 25 and 40 m·Pas at 25 degrees Celsius.

55. Method according to any of clauses 48-54, wherein at least part of the cellulose particles, in particular wood fibers, provided at step a) have a moisture content between 5 and 20% by weight, preferably between 7.5 and 15% by weight, and more preferably between 10 and 12% by weight.

56. Method according to any of clauses 48-55, at least one additive is added during or after step b).

57. Method according to any of clauses 48-56, wherein during step b) at least part of the cellulose particles, in particular wood fibers, are sprayed with binder.

58. Method according to any of clauses 48-57, wherein at least part of the mixture of cellulose particles, in particular wood fibers, and binder is conditioned prior to step c) such that the moisture content is 1 to 6% by weight, in particular 2 to 5% by weight, and more in particular 3 to 4% by weight.

The invention will be further elucidated based upon the following non-limitative figures. Herein shows:

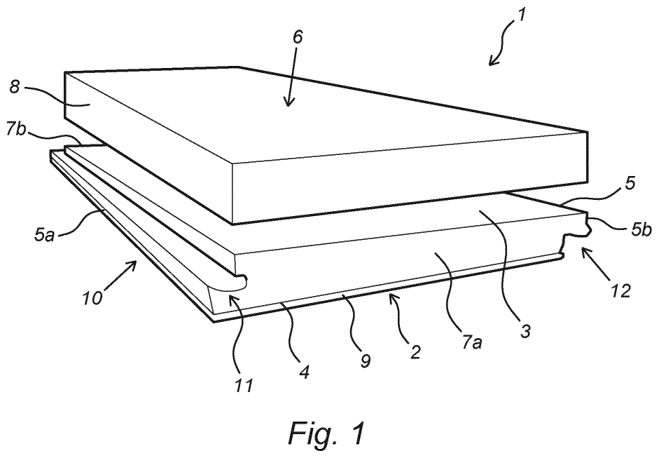

FIG. 1 an exploded perspective view of a panel according to the present invention;

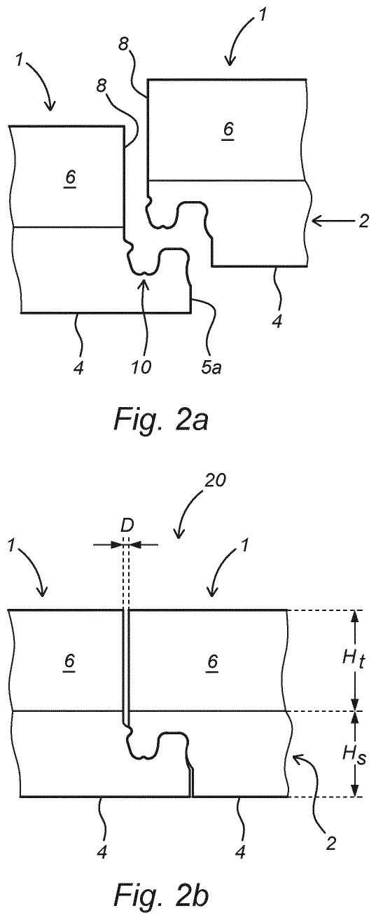

FIGS. 2a and 2b cross sectional view of panels according to the present invention;

Within these figures, similar reference signs correspond to similar or equivalent features or elements.

FIG. 1 shows a schematic representation of a panel 1 according to the present invention. The panel is configured for constructing a floor or wall covering, and comprised a substantially flat support element 2 which comprises an upper surface 3, a lower surface 4, a first pair of opposed side edges 5a, 5b and a second pair of opposed side edges 7a, 7b. Further a decorative top layer 6 is configured to be affixed to the upper surface 3 of the support element 6. The support element 2 comprises wood fibers and/or plant fibers, and at least one binder has a density of at least 1000 kg/m3. In the shown embodiment, a backing layer 9 is attached to the lower surface 4 of the support element. It is to be understood that, in other embodiments, the support element 2 may assume various shapes, different from the shown rectangular shape. For example, the support element 2 may have diamond or square shape. In further embodiments, the support element 2 may be a polygon with a number of sides greater than four. Also in this case the opposed side edges 5a, 5b, 7a, 7b are consecutive one to the other and alternate in sequence to each other. Typically, the support element 2 has a thickness between 2 and 12 millimeters, preferably between 2 and 10 millimeters. In the shown embodiment, the support element 2 is provided with interconnecting coupling means 10. The coupling means 10 are in the shown embodiment a combination of a female coupling part 11 and a male counter coupling part 12. The support element 2 and the top layer 6 can be mutually affixed via an adhesive layer (not shown).

FIGS. 2a and 2b show a cross sectional view of panels 1 according to the present invention. It can be seen that two adjacent panels 1 can be interconnected via the coupling means 10. The thickness Ht of the top layer 6 is larger than the thickness Hs of the support element 2. It can be seen that the top layer 6 does not protrudes outside the perimeter of the upper surface 3 of the support element 2. FIG. 2b shows an embodiment, wherein, in an assembled condition, the adjacent panels 1 are arranged such that a predetermined distance D is defined between the side surfaces 8 of the top layers 6. The distance D can for example be between 0 and 4 millimeters, and preferably between 1 and 2.5 millimeters. Once the floor or wall covering is provided, it is possible to seal the distance D between two adjacent panels, for example with sealing means. This can for example be done with resins for joints which are typically used in the construction industry such as water-based resins, epoxy and/or cement resins.

The above-described inventive concepts are illustrated by several illustrative embodiments. It is conceivable that individual inventive concepts may be applied without, in so doing, also applying other details of the described example. It is not necessary to elaborate on examples of all conceivable combinations of the above-described inventive concepts, as a person skilled in the art will understand numerous inventive concepts can be (re)combined in order to arrive at a specific application.

It will be apparent that the invention is not limited to the working examples shown and described herein, but that numerous variants are possible within the scope of the attached claims that will be obvious to a person skilled in the art.

When it is referred to a ‘panel’, also the term ‘tile’ or ‘prefabricated element’ could be used. The verb “comprise” and conjugations thereof used in this patent publication are understood to mean not only “comprise”, but are also understood to mean the phrases “contain”, “substantially consist of”, “formed by”, “is” and conjugations thereof, and vice versa.

1.-61. (canceled)

62. Panel for constructing a floor or wall covering, comprising:
at least one substantially flat support element comprising: an upper surface, a lower surface, a first pair of opposed side edges and a second pair of opposed side edges, wherein the support element is waterproof and, wherein the waterproof support element is at least partially made of a composite material, which composite material comprises:
at least one binder selected from the group consisting of: a thermosetting binder, and a mineral binder, in particular gypsum, clay or cement;
natural particles, in particular natural fibers, dispersed in said binder, wherein at least one type of natural particles is chosen from the group consisting of: plant particles, wood particles, and animal particles; and
less than 20% by weight of thermoplastic material,
and
at least one decorative top layer which is affixed, either directly or indirectly, to the upper surface of the support element, wherein the top layer is at least partially made of at least one material chosen from the group consisting of: ceramic, stone, concrete, mineral porcelain, glass, mosaic, granite, limestone and marble.

63. A panel according to claim 62, wherein the composite material is free of thermoplastic material.

64. A panel according to claim 62, wherein the binder is a thermosetting polymer binder chosen from the group consisting of: an epoxy resin, an acrylic resin, a polyurethane resin and a phenolic resin.

65. A panel according to claim 62, wherein the binder is a phenol-formaldehyde resin having a formaldehyde to phenol ratio which is at least 1.

66. Panel according to claim 62, wherein the composite material comprises a mineral binder comprising gypsum.

67. A panel according to claim 62, wherein the natural particles, in particular natural fibers, are at least partially encapsulated by said binder.

68. A panel according to claim 62, wherein the natural particles comprises plant particles comprising bamboo particles, hemp particles, grass particles, and/or seagrass particles.

69. A panel according to claim 62, wherein the natural particles comprises plant particles comprising at least 60% by weight of cellulose.

70. A panel according to claim 62, wherein the natural particles comprises plant particles comprising cellulose having a cellulose crystallinity of at least 80% by weight of the total amount of cellulose.

71. A panel according to claim 62, wherein the natural particles comprises plant particles comprising less than 10% by weight of lignin.

72. A panel according to claim 62, wherein the natural particles comprises plant particles comprising wood flour and/or wood fibers and/or leather particles.

73. A panel according to claim 62, wherein the composite material comprises between 1% and 60%, in particular between 2% and 40%, by weight of natural particles.

74. Panel according claim 62, wherein the support element has a density of at least 1000 kg/m3, preferably at least 1100 kg/m3, more preferably at least 1200 kg/m3 and most preferably at least 1300 kg/m3.

75. A panel according to claim 62, wherein the support element consists of a single material layer.

76. A panel according to claim 62, wherein the support element has a thickness between 2 and 12 mm, preferably between 2 and 10 mm, more preferably between 2 and 6 mm.

77. A panel according to claim 62, wherein at least one pair of opposed side edges is provided with interconnecting coupling profiles for interconnecting adjacent panels, wherein the panel comprises, at a first pair of opposed side edges, a first and a second coupling profile, wherein the first coupling profile and the second coupling profile are configured such that the first and second coupling profiles of two identical panels can be coupled to each other by means of a vertical movement, and wherein the panel comprises, at a second pair of opposed edges, a third coupling profile and a fourth coupling profile, wherein the third coupling profile and the fourth coupling profile are configured such that the third and fourth coupling profiles of two identical panels can be coupled to each other by means of a turning movement.

78. A panel according to claim 62, wherein the support element is larger than the decorative top layer, and wherein the coupling profiles are situated at a distance from the top layer.

79. A panel according to claim 62, wherein the support element and the top layer are mutually affixed via a hot melt adhesive layer.

80. A panel according claim 62, wherein the panel comprises at least one reinforcing layer embedded in said support element, wherein the reinforcing layer is preferably a glass-fiber layer.

81. A method of manufacturing a panel for constructing a floor or wall covering, in particular a panel according to claim 62, comprising the steps:
a) providing a quantity of cellulose particles,
b) mixing of the natural particles with at least one binder,
c) hot pressing of the mixture of natural particles and binder at a temperature of at least 120 degrees Celsius, such that a substantially flat support element having a density of at least 1000 kg/m3 is obtained, and
d) attaching at least one decorative top layer to the support element.
